(19) United States
(12) Patent Application Publication
(10) Pub. No.: US 2013/0158687 A1
(43) Pub. Date: Jun. 20, 2013

(54) System and Method for Obtaining Performance Metrics During Sports Training and Entertainment

(71) Applicant: John Willenborg, Novato, CA (US)

(72) Inventor: John Willenborg, Novato, CA (US)

(21) Appl. No.: 13/723,049

(22) Filed: Dec. 20, 2012

Related U.S. Application Data
(60) Provisional application No. 61/577,666, filed on Dec. 20, 2011.

(51) Int. Cl. G06F 17/40

(52) U.S. Cl. CPC G06F 17/40
USPC 700/91

(57) ABSTRACT

The present disclosure discloses a system and method for obtaining data signatures and displaying performance metrics during sports training and for entertainment. The method includes utilizing computer application software installed on a mobile device having conventional smart phone hardware to record data signatures, and in return, displaying performance metrics back to a user in a meaningful way, The computer application software is operable to record data obtained by conventional smart phone hardware such as, but not limited to, an accelerometer, GPS receiver, tilt sensor, and radiometer. The method further includes reviewing the performance metrics displayed by the computer application software, and in response to reviewing the metrics, making adjustments to improve one's performance while participating in subsequent action sports activities.

### FIELD

The present disclosure relates to obtaining and displaying performance metrics during sports training and for entertainment.

### BACKGROUND

Action sports have even become increasingly competitive. In fact, many participants undergo extensive training to perform at their best during contests. For example, some participants mount cameras and data acquisition units to their sporting equipment to capture performance data during training. However, these items are often bulky and expensive.

Moreover most camera and data acquisition equipment have limited recording and display capability and require additional sensors to be mounted throughout the sporting equipment. In addition, conventional proprietary hardware generally captures limited performance data for participants desiring to significantly increase their performance. For example, conventional proprietary hardware may capture one's speed along a course but may not render lean angle air time or other useful metrics.

As such, there exists a need to provide an inexpensive, lightweight, and portable data gathering solution and display solution for sports training and for entertainment. The present disclosure addresses such a need.

### SUMMARY

The present disclosure discloses a system and method for obtaining data signatures and displaying performance metrics during sports training and for entertainment. The method includes utilizing computer application software installed on a mobile device having conventional smart phone hardware to record data signatures, and in return, displaying performance metrics back to a user in a meaningful way. The computer application software is operable to record data obtained by conventional smart phone hardware such as, but not limited to, an accelerometer, GPS receiver, tilt sensor, and radiometer. The method further includes reviewing the performance metrics displayed by the computer application software, and in response to reviewing the metrics, making adjustments to improve one's performance while participating in subsequent action sports activities.

### BRIEF DESCRIPTION OF THE FIGURES

For a fuller understanding of the nature and objects of the disclosure, reference should be made to the following detailed description taken in connection with the accompanying drawing forming a part of this specification and in which similar numerals of reference indicate corresponding parts in all the figures of the drawing:

FIG. 1 illustrates a perspective view of a motorist upon a motor bike, with a mobile device mounted thereon, according to some embodiments of the present disclosure.

FIG. 2 illustrates a perspective front view of a smart phone, having a computer application software installed thereon, according to some embodiments of the present disclosure.

FIG. 3 illustrates a perspective view of a motorist operating a motor bike having a mobile device mounted thereto wherein the mobile device has computer application software installed thereon, according to some embodiments of the present disclosure.

FIG. 4 illustrates a perspective view of an outlay distribution of specific forces along a simulated track traversed by the motorist displayed in FIG. 3, according to some embodiments of the present disclosure.

FIG. 5 illustrates a perspective view of a skateboarder riding a skateboard having a mobile device mounted thereto wherein the mobile device has computer application software installed thereon, according to some embodiments of the present disclosure.

FIG. 6 illustrates a perspective view of an outlay distribution of specific forces along a simulated ramp traversed by the skateboarder displayed in FIG. 5, according to some embodiments of the present disclosure.

### DETAILED DESCRIPTION

The present disclosure relates generally to action sports, and more particularly, to obtaining data signatures and displaying performance metrics during sports training and for entertainment. The following description is presented to enable one having ordinary skill in the art to make and use the embodiment and is provided in the context of a patent application. The generic principles and features described herein will be apparent to those skilled in the art. Thus, the present embodiment is not intended to be limited to the embodiments shown, but is to be accorded the widest scope consistent with the principles and features described herein.

The present disclosure discloses a system and method for obtaining data signatures and displaying performance metrics during sports training and for entertainment. The method includes utilizing computer application software installed on a mobile device having conventional smart phone hardware to record data signatures, and in return, displaying performance metrics back to a user in a meaningful way. The computer application software is operable to record data obtained by conventional smart phone hardware such as, but not limited to, an accelerometer, GPS receiver, tilt sensor, and radiometer. The method further includes reviewing the performance metrics displayed by the computer application software and in response to reviewing the metrics, making adjustments to improve one's performance while participating in subsequent action sports activities.

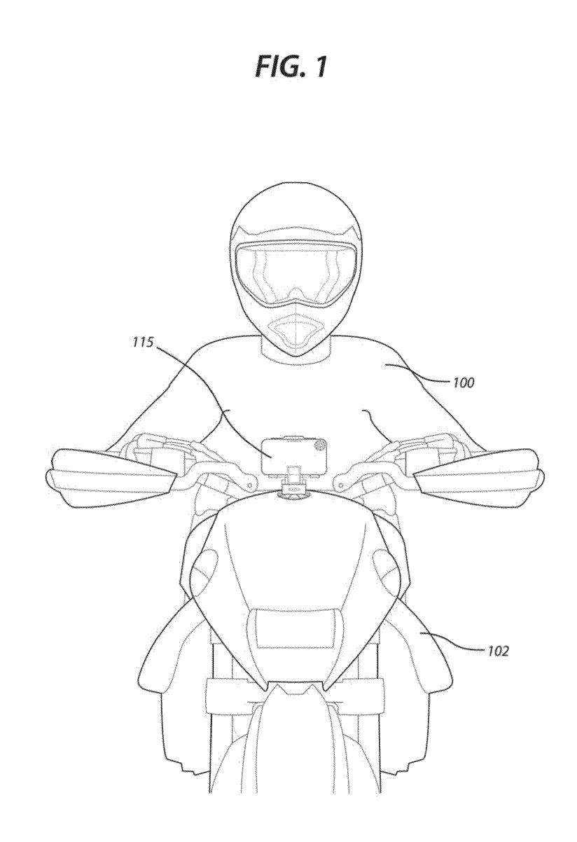

FIG. 1 illustrates a perspective view of a motorist 100 upon a motor bike 102, with a mobile device 115 mounted thereon, according to an embodiment of the present disclosure. In some embodiments, mobile device 115 is a smart phone. It should be appreciated by those having ordinary skill in the art, however, that the present disclosure is not limited to mounting a smart phone to sporting equipment. As such, any device having the necessary components and functionality disclosed in the present disclosure may be coupled to a motorist's person or sporting equipment by any means so long as the mobile device 115 captures data signatures and displays performance metrics of the motorist's performance.

One having ordinary skill in the art should appreciate that a motorist is not limited to an individual operating a motor vehicle but may include an individual operating any sporting equipment such as, but not limited to, a racing bicycle or skateboard. Accordingly, an individual operating a skateboard (e.g. a “skateboarder”) may also be referred to as a motorist in the present application.

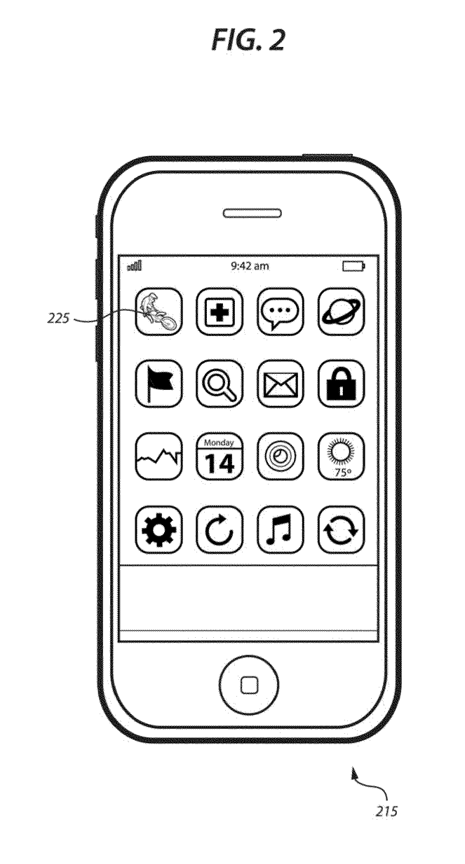

Continuing on through the figures, FIG. 2 illustrates a perspective front view of a smart phone 215, having computer application software installed thereon, according to some embodiments of the present disclosure. In some embodiments, smart phone 215 is a high-end mobile device which includes the functionality of a personal digital assistant (PDA) and a conventional mobile phone. In some embodiments, smart phone 215 includes advanced computing capability and connectivity. Smart phone 215 may be operable to run mobile operating systems such as, but not limited to, Apple's iOS, Google's Android, Microsoft's Windows, Nokia's Symbian, RIM's BlackBerry OS, and embedded Linux distributions such as Maemo and MeeGo.

In some embodiments of the present disclosure, smart phone 215 contains common mobile hardware components such as, but not limited to, an accelerometer, GPS receiver, gyroscope, tilt sensor and radiometer. The aforementioned hardware components may be used by computer applications software to obtain data relevant to improving one's performance participating in action sports activities.

For example, an accelerometer can be used to measure acceleration and deceleration. In particular, an accelerometer can be used to measure acceleration associated with the phenomenon of weight experienced by a test mass resident in a frame of reference of the accelerometer hardware component of the smart phone 215. Accordingly, an accelerometer can measure weight per unit of (test) mass otherwise referred to as “specific force” or “g force:”

A GPS (Global Positioning System) receiver component can obtain location coordinates and calculate velocity. An inclinometer component such as a tilt sensor can measure the degree an object tilts in two axes. In the present disclosure, a tilt sensor component may be used to measure the slope sporting equipment undergoes while in operation.

Finally, an accelerometer and radiometer can collectively detect and record three dimensional (3D) movement data. In some embodiments, data obtained by the smart phone's 215 hardware components may be collectively referred to as “data signatures” which may be used by computer application software to render performance data which may be displayed to a user (e.g. motorist) in a meaningful way.

The hardware components may be configured to measure the specific force exerted upon a course according to a predetermined frequency. For example, computer application software 225 can gather specific forces every five-hundred milliseconds, second, two seconds, fifteen seconds, thirty seconds, or each minute. In some embodiments of the present disclosure, computer application software 225 obtains specific force data every 500 milliseconds. Moreover, in addition to obtaining data signatures from hardware components, computer software application can upload data to another computing or electronic storage device (e.g. a server) via wireless mechanisms (technologies) and hardware know in the art.

It should be appreciated that the computer application software 225 can be used to obtain data signatures on any predetermined frequency. As such, a user can set the software 225 to record and capture data signatures more or less frequently depending on a user's desire or memory capacity within their mobile device 215.

Furthermore, the computer application software 225 can display performance data real time from the data signatures obtained. For example, computer application software 225 can readily display location, velocity, three dimensional movement, specific force, and acceleration data real time.

FIG. 2 further illustrates an icon 225 of a computer application software which can be selected by a user to launch the computer application software. In some embodiments, computer application software is operable to record data signatures and in return display performance metrics back to the user in a meaningful way. Throughout the application, the computer application software accessible via icon 225 will be referred to as computer application software 225.

In some embodiments, computer application software 225 is a third party application that uses advanced application programming interfaces (APIs) to allow the application to have better integration with the smart phone's 215 operating system (OS) and hardware. Most notably, computer application software 225 can create a simulation of a motorist's performance(s) along a track to which motorist and other interested parties can view to determine improvement areas for subsequent rides. As such, the computer application software's 225 simulation feature can be very useful for actions sports enthusiasts for training and for entertainment purposes.

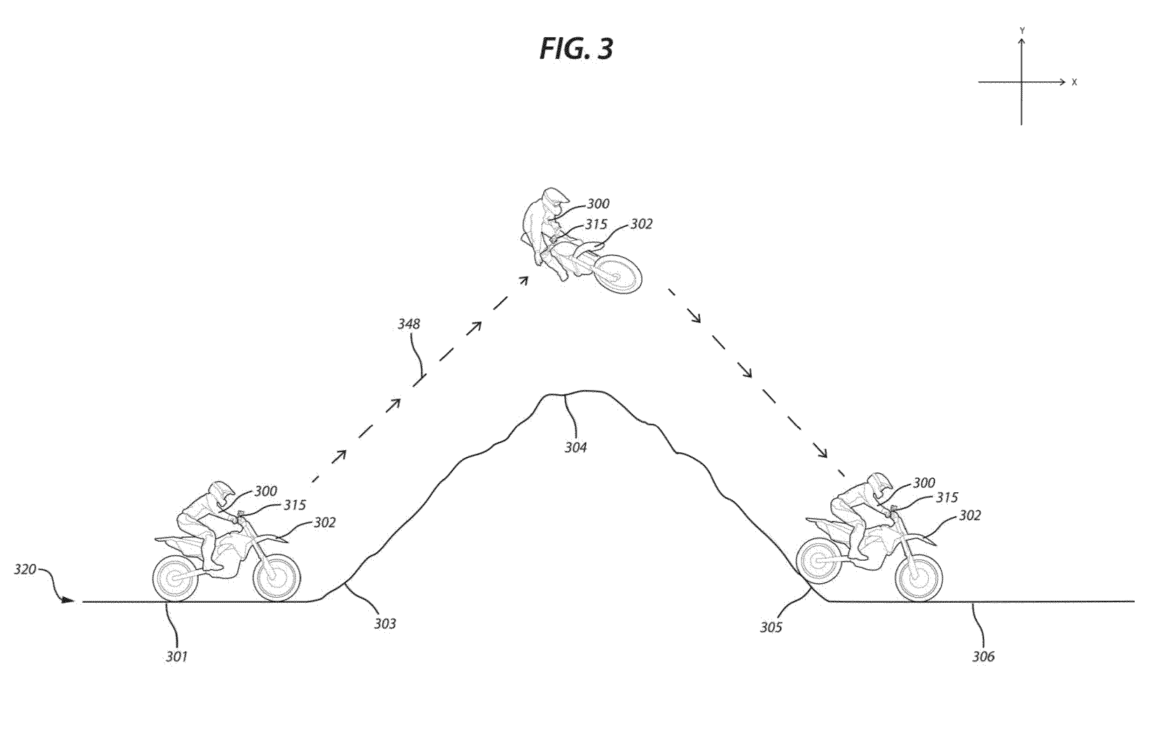

FIG. 3 illustrates a perspective view of a motorist 300 operating a motor bike 302 having a smart phone 315 mounted thereto wherein the smart phone 315 has computer application software (described in relation to FIG. 2) installed thereon with the functionality described in the present disclosure.

As illustrated motorist 300 is shown riding (see arrows 348) along track 320. When motorist 300 reaches the ramp (section 303), the motorist 300 is shown to have maneuvered the motor bike 302 to propel the bike 302 (along with the motorist) in the air. Next, when the bike 302 contacts the ramp, the bike 302 accelerates significantly in the X direction while decelerating in the Y direction. It should be understood by one having ordinary skill in the art that a track 320 is exemplary and may not be drawn to scale.

Once the collective body of the motorist 300 and bike 302 is airborne, the acceleration of the body in the X direction eventually decreases to zero and the collective body begins to accelerate in the −X direction while the deceleration in the Y direction continues but at a slower rate. Upon landing there is an acceleration of the collective body in the X direction until zero is reached. Once the bike 302 is in the air, the motorist 300 can bend the bike 302 to scrub-off speed (e.g. “scrubbing”) while enabling the motorist 300 to power the bike 302 forward and over the ramp, according to an embodiment of the present disclosure.

In time, gravity causes the collective body to fall downwards until the body reaches the track 320. As shown in FIG. 3, motor bike 302 lands near sections 305, 306 of the track 320 where the motorist 300 regains control and continues driving along the course.

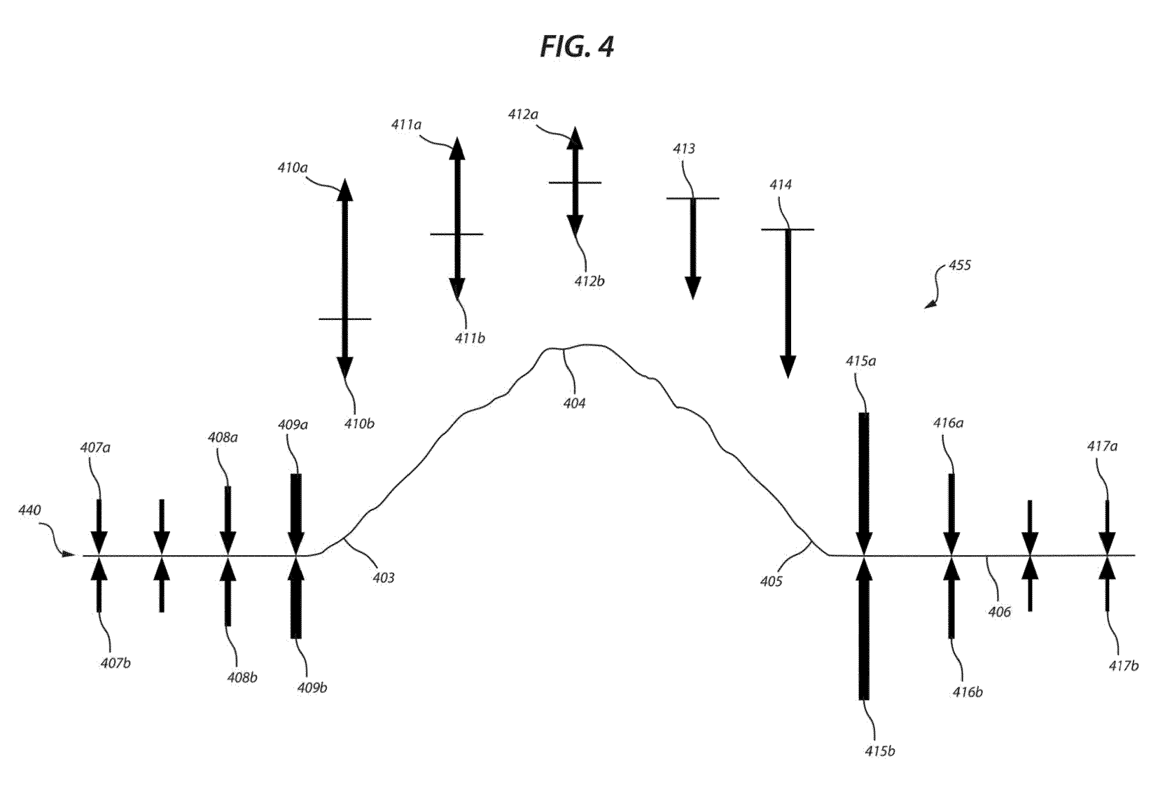

FIG. 4 illustrates a perspective view of an outlay distribution of specific forces along a simulated track traversed by the motorist 300 displayed in FIG. 3, according to some embodiments of the present disclosure. However, while referring to the objects described in FIG. 4, FIG. 3 may also be referenced.

Simulation 455 shows a distribution of specific forces illustrated by force intensity arrows (e.g. 407a, 407b) exerted by the motor bike 302 at distinct locations along the track 320. The series of vertical forces include pairs of forces which are equal and opposite to each other in accordance with Newton's Third Law of Motion—any force exerted upon an object has an equal counterpart force that is exerted in the opposite direction back onto the object. For example, FIG. 4 illustrates force intensity arrow 407a and its counterpart, force intensity arrow 407b.

It should be appreciated that the force intensity arrows may differ in length. For example, force intensity arrow 408a is longer than force intensity arrow 407a because the specific force exerted by the bike 302 upon the track 320 at the location of arrow 408a is greater than the specific force exerted by bike 302, at the location of arrow 407a.

Moving along simulated track 440, force intensity arrow 409a indicates that motor bike 302 exerted a greater specific force upon the simulated track 440 at the location pointed to by arrow 409a than exerted at the previous location of arrow 408a. In some embodiments, the increase in specific force at the location of arrow 409a correlates to the motorist's 300 attempt to maneuver the motor bike 302 to propel it in the air. One having ordinary skill in the art will appreciate that motorist often push down on the handle bars and front tire of a motor bike upon contacting the ramp to propel the bike in the air to a certain height for a predetermined period of time (air time).

As the motor bike 302 elevates into the air, the upward force due to the velocity of the bike 302, along with the motorist's 300 maneuvering technique(s), exceeds the downward gravitational force. As such, the offset between the vertical forces causes the collective body to upwardly displace in the air. It should be understood by one having ordinary skill in the art that the terms “gravity,” “gravitational force,” “force of gravity,” or “gravitational pull” refers to the product of a mass of an object and the gravitational acceleration—approximately 9.8 m/s² . Accordingly, any reference to the aforementioned terms refers to the gravitational acceleration on the mass of an object.

Moving forward, simulation 455 further illustrates the resulting upward displacement, or lift, exhibited by force intensity arrows 410a, 410b. As shown, the length of force intensity arrow 410a exceeds the length of force intensity arrow 410b which illustrates how the collective body rises in the air. As the motor bike 302 glides in the air, the gravitational acceleration decreases the rate to which the collective body elevates in the air, indicative by force intensity arrow 411a. However, since the upward vertical force is greater than the downward gravitational force, the collective body (e.g. motorist 300 and bike 302) continues to rise in the air.

Once the gravitational force decreases the rate of rise such that the upward force upon the collective body (e.g. exhibited by force intensity arrow 412a) is equal but opposite to the gravitational force, (e.g. exhibited by force intensity arrow 412b), both motorist 300 and motor bike 302 experience a state of “weightlessness.” This state of “weightlessness” may be characterized as a specific force of zero force per unit mass (e.g. zero g-forces) applied to a body in air. With respect to FIG. 4, weightlessness may be further characterized as the moment when the collective body reaches its vertical apex.

In time, the collective body begins to fall downward due to the gravitational force acting upon the objects, illustrated by force intensity arrows 413, 414. It should be understood by one having ordinary skill in the art that only a single vertical force (e.g. gravitational force) acts upon the collective body after it reaches its vertical apex over the track 440. As such, gravity will cause the collective body to fall downward at an increasing rate as indicated by force intensity arrows 413, 414. Once motor bike 302 lands on track 320, the resulting impact exerts a considerable force upon the track 320 (sections 305, 306), However, the specific force applied by motor bike 302 to the track 320 levels off in time as indicated by force intensity arrows 416a, 416b, 417a, and 417b.

Accordingly, a computer application software installed on a smart phone 315 described in the present disclosure may serve as a useful tool to help one improve performance during sports training and for entertainment. For example, the computer application software can display a simulation of one's ride and an outlay distribution of specific forces at precise locations along a track, map a motorist's path along a course, and calculate and display velocity and airtime during jumps.

A user may utilize these data signatures, along with other data to determine how to plan jumps, maximize jumps, control the amount of airtime and scrubbing, and determine when to accelerate along a course.

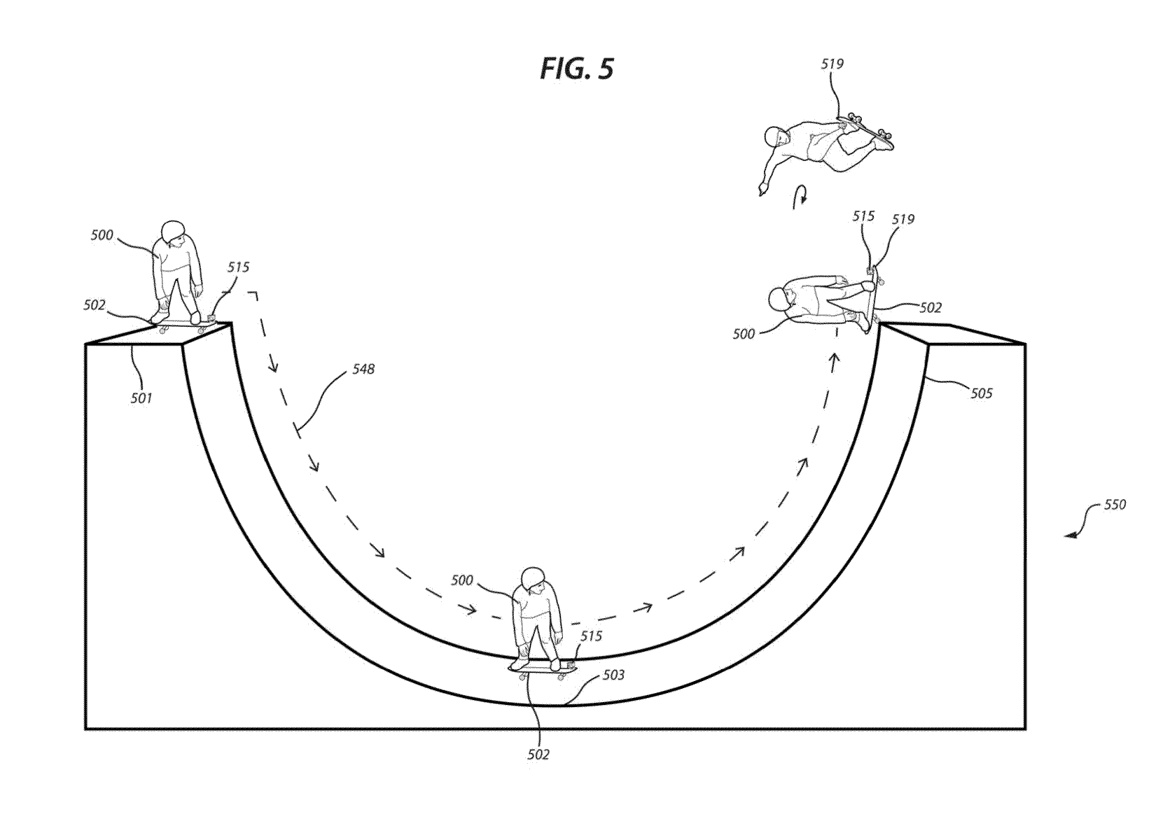

FIG. 5 illustrates a perspective view of a skateboarder riding a skateboard having a mobile device mounted thereto wherein the mobile device has computer application software installed thereon, according to some embodiments of the present disclosure. In the embodiment shown, mobile device 515 and the computer application software installed thereon collectively contains the hardware features and functionalities of smart phone 215, 315 and computer application software 225 described above.

FIG. 5 shows skateboarder 500 stationed with a skateboard 502 upon platform 501 in preparation to ride along a ramp 550. As shown, ramp 550 is shaped as an inverted parabolic curve such that skateboarder 500 can gain sufficient speed to perform tricks. Once skateboarder 500 propels skateboard 502 from the edge of the platform 501, the collective body (see arrow 548) accelerates along the ramp 550 due to gravity. The skateboarder 500 achieves maximum speed along the ramp 550 when the skateboarder 500 reaches the base 503 of the ramp 550.

Moving along the ramp 550, skateboarder 500 eventually reaches the edge 505 where the skateboarder 500 can perform tricks or terminate the riding session. In some embodiments, skateboarder 500 coasts off the ramp 550 and performs a “180” skating trick by turning the skateboarder's 500 body and the skateboard 502 one hundred and eighty degrees back in the direction of the ramp 550 (see tip 519 of skateboard 502). By using a system and method consistent with the present disclosure, a skateboarder can improve their skating performance to perfect skateboarding techniques and tricks (e.g. “180”) during contests or for entertainment purposes.

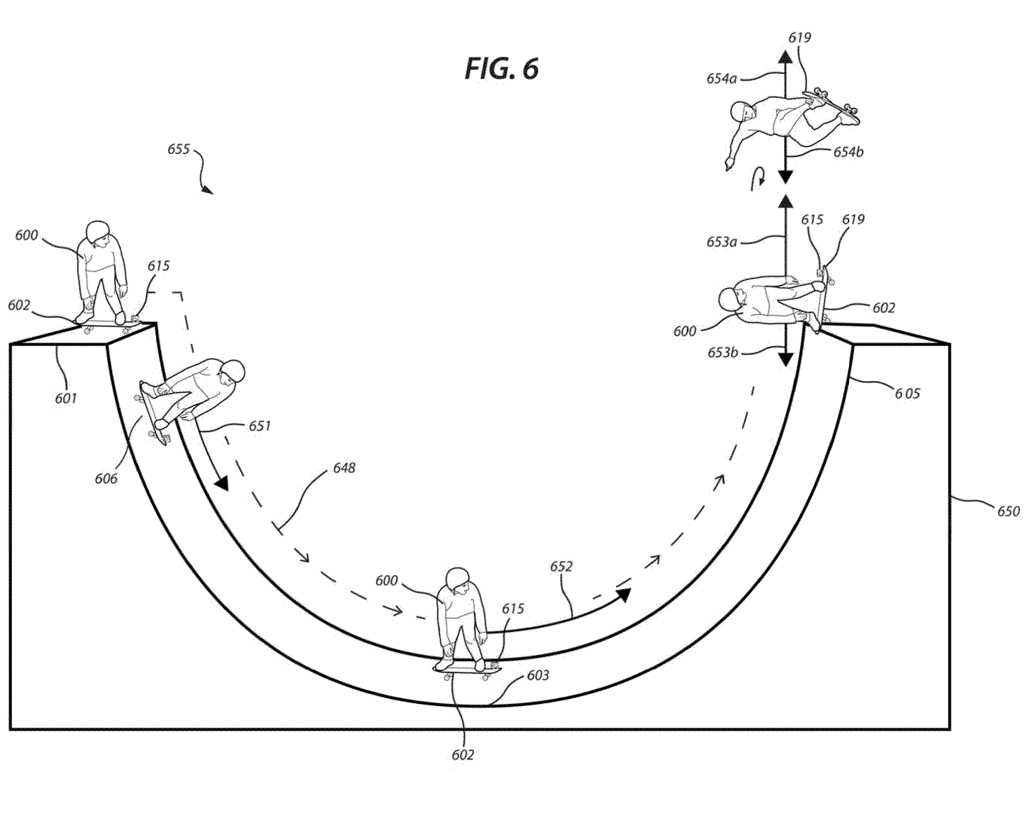

FIG. 6 illustrates a perspective view of an outlay distribution of specific forces along a simulated ramp 650 traversed by the skateboarder 500 displayed in FIG. 5. In particular, simulation 655 exhibits the intensity of specific forces exerted by the skateboard 602 as the skateboarder 600 rides along the ramp 650.

Simulation 655 shows the vertical force upon the collective body at section 606 of the ramp 650 (indicated by force intensity arrow 651). In the embodiment shown, force intensity arrow 651 is equal to the gravitational force exerted on the collective body along the ramp 650. Skateboarder 600 relay achieve maximum speed at the base 603 of the ramp 650, as shown by the length of force intensity arrow 652.

Moving along the ramp 650, skateboarder 600 continues coasting until he/she reaches the edge 605. At this point along the ramp 650, the skateboarder 600 may have enough momentum, obtained by the gravitational force exerted upon the collective body, to coast off the ramp 650 and perform tricks.

Since the upward vertical force (indicated by force intensity arrow 653a) exceeds the downward vertical force, the gravitational force (indicated by force intensity arrow 653b) causes the collective body to rise in the air. However, because the gravitational force increases due to acceleration, the collective body will be limited to how high the body will travel and will finally reach its vertical apex (exhibited by force intensity arrows 654a, 654b). Accordingly, computer application software can create a simulation of skateboarder's performance(s) along a track to which the skateboarder and other interested parties can view to determine improvement areas to implement during subsequent rides.

Accordingly, the present disclosure addresses a need to provide an inexpensive, lightweight, and portable data gathering and display solution, helpful to motorist seeking to improve their performance during sporting contests and for entertainment.

This disclosure relates generally to action sports, and more particularly, to obtaining data signatures and displaying performance metrics during sports training and for entertainment purposes. It will be understood by those having ordinary skill in the art that the present disclosure may be embodied in other specific forms without departing from the spirit and scope of the disclosure disclosed. In addition, the examples and embodiments described herein are in all respects illustrative and not restrictive. Those skilled in the art of the present disclosure will recognize that other embodiments using the concepts described herein are also possible.

What is claimed is:

1. A method, comprising:
utilizing computer application software installed an a mobile device to obtain and record data signatures and in return display performance metrics back to a user;
wherein the mobile device comprises an accelerometer, GPS receiver, gyroscope, tilt sensor, and radiometer;
reviewing the performance metrics displayed by the computer application software and in response to reviewing the performance metrics making adjustments to improve a user's performance when participating in subsequent action sports activities.

2. The method of claim 1, wherein the computer application software can obtain at least one of location, velocity, three dimensional movement, specific force, and acceleration data.

3. The method of claim 1, wherein the computer application software can upload the data to a computing device.

4. The method of claim 3, wherein the computing device is a server.

5. The method of claim 1, wherein the performance data is displayed real-time.

6. The method of claim 1, wherein the data signatures are collected on a predetermined frequency.

7. The method of claim 1, wherein the computer application software can generate a simulation of motorist activity from the data signatures.

8. The method of claim 7, wherein the simulation displays a set of specific forces corresponding to a motorist trek along a track.

9. The method of claim 7, wherein the simulation is at least one of a ride of a skateboard along a ramp or a ride of a motorist along a track.

10. The method of claim 1, wherein the accelerometer and radiometer are collective used to detect and record three dimensional movement data.

11. The method of claim 1, wherein the computer application software records specific force data every 500 milliseconds.

12. The method of claim 1, wherein the mobile device is coupled to sporting equipment prior to obtaining and displaying the data signatures.

13. The method of claim 1, wherein the performance data is displayed by the mobile device.

14. The method of claim 1, wherein the performance data is displayed by a computing device after downloading the performance data from a server.

15. The method of claim 1, wherein the mobile device comprises a functionality of a personal digital assistant device and a mobile phone device.
